(19) United States
(12) Patent Application Publication
(10) Pub. No.: US 2008/0041235 A1
(43) Pub. Date: Feb. 21, 2008

(54) Coffee Machine

(75) Inventors: Siegmund Kramer, Kirchanschoring (DE); Albert Ostermaier, Stein a.d. Traun (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/793,102

(22) PCT Filed: Mar. 8, 2005
(86) PCT No.: PCT/EP05/51024

§ 371 Date: Jun. 15, 2007

(30) Foreign Application Priority Data
Dec. 27, 2004 (DE) 10 2004 062 746.0

(51) Int. Cl. A47J 31/44; A47J 31/06

(52) U.S. Cl. 99/293

(57) ABSTRACT

A coffee machine comprising a heating device for heating water, a brewing chamber for accommodating a coffee pad to which water heated by the heating device is supplied in order for the coffee pad accommodated in the brewing chamber to develop its flavor, an outlet for the coffee so produced and a steam generator with a steam outlet for providing steam.

The invention relates to a coffee machine comprising a heating device for heating water, a brewing chamber for accommodating a coffee pad, to which brewing chamber, during operation, water heated by the heating device is fed under pressure of 3 bar maximum in order to release flavorings from a quantity of ground coffee which is located in a coffee pad arranged during operation in said brewing chamber, and an outlet for the coffee so produced.

Coffee machines of the type specified in the introduction are described for example in WO 01/15582 A1 or EP 1 050 248 A1. The “coffee pads” used therein are normally formed from two sheets of filter paper connected to one another at the edge and containing the ground coffee in their central area. Such a coffee pad is simply inserted into the open brewing chamber of the pad coffee machine. The brewing chamber is then closed via a locking mechanism. Hot water is subsequently forced under a pressure of 3 bar maximum into the brewing chamber and in this way the flavorings and colorings released from the ground coffee in a comparatively gentle way, the coffee which is produced in the process being extracted through the outlet. The brewing chamber can subsequently be re-opened and the used coffee pad disposed of. Such “pad coffee machines” are enjoying increasing popularity among consumers since these machines—unlike the usual domestic coffee machines in which water is fed to the ground coffee with which a coffee filter has been filled and the finished coffee then trickles through the coffee filter into a pot—make it possible for fresh coffee to be produced in portions or cups as required.

Compared with the classic espresso machines in which water is forced under a pressure of up to 12 bar into the brewing chamber, the pad coffee machines have the advantage of being considerably simpler, faster and more convenient to operate both in terms of the preparation for a brewing process and in the subsequent disposal of the used coffee and cleaning of the machine. Moreover, these devices are generally of a considerably more space-saving design than classic espresso machines. Where coffee pads containing a ground coffee of the appropriate taste are used, such a machine can, for example, also produce an espresso-type coffee.

The object of the present invention is to further develop a pad coffee machine of the type specified in the introduction with the aim of extending the possible applications of the coffee machine.

This object is achieved in a coffee machine as recited in the claims.

According to the invention, the coffee machine comprises a heating device for heating water, a brewing chamber for accommodating a coffee pad, to which brewing chamber water heated by the heating device is fed in order to release flavorings from a coffee pad arranged in said brewing chamber, an outlet for the coffee so produced and a steam generator with a steam outlet for providing steam.

By means of such a pad coffee machine according to the invention, the user can generate hot steam as in a classic espresso machine and thus, for example, froth up milk in order to prepare cappuccino, latte macchiato or the like in a style true to the original in addition to normal coffee and expresso-type coffee. Such a pad coffee machine according to the invention is therefore not only more convenient and simpler to operate than a classic espresso machine but furthermore also offers the complete range of functions of an espresso machine, which considerably increases the attraction of a pad coffee machine for the user.

The heating device comprises according to a preferred embodiment of the inventive coffee machine a continuous-flow heater. The use of the continuous-flow heater is more space-saving than the normal use of a kind of boiler, as is the case e.g. in the previously known pad coffee machines.

If the inventive coffee machine has just one heating device, as is provided according to a particularly preferred embodiment, then the same heating device is used for the steam generator as for coffee preparation, but controllable in a suitable manner.

Where just one heating device is used, the heating device feeds the heated water preferably under a pressure of 3 bar maximum and/or the inventive coffee machine comprises a control system by means of which the heating device can be switched at least between two operating states, the heating device in a first operating state heating water to a first temperature value for preparing coffee and in a second operating state heating water to a second temperature value for generating steam. In the first operating state, the heating device heats water to the first temperature value of, for example, approximately 100° C. for preparing coffee, i.e. for overbrewing the ground coffee. In the second operating state, water is heated by the heating device to the second temperature value of, for example, approximately 130° C. in order to generate steam.

Further advantageous embodiments of the inventive coffee machine are described in further dependent claims.

If the heating device comprises a pump, then a pump control is preferably assigned to the pump, which pump control is designed such that in a steam-generating operating state the pump feeds water to the heating device in a predetermined cycle. That is, the pump is not operated full-time during steam generation, but is switched on and off via the control at defined intervals. This cyclical operation of the pump ensures that steam is generated evenly in the continuous-flow heater and an overheating of the heating element(s) of the continuous-flow heater is avoided. The switching times are in a particularly preferred embodiment chosen such that about every 3 s-10 s, preferably every 5 s, the pump is operated for approximately 0.3 s up to 1 s, preferably 0.6 s.

According to a variant of the coffee machine according to the invention, the steam generator has a steam separator connected downstream of the heating device. Such a steam separator (or water separator) ensures that the water component of the steam/water mixture normally coming from the heating device (i.e. of the so-called wet steam) is separated. The remaining steam component which can be discharged through the steam outlet, then has only a reduced water content remaining, i.e. it is a dried steam. This on the one hand reduces the risk that the milk will be overheated when being frothed up and on the other enables the coffee machine—without this leading to a fall in quality in the generation of steam—to be equipped with a single heater that is designed for lower temperatures. Due to the energy savings, this is more cost-effective, both in the production of the coffee machine and in the operation thereof.

Such a steam separator is preferably formed in a relatively simple manner from a chamber comprising an inlet aperture for the steam/water mixture, i.e. the wet steam, a steam outlet aperture arranged in an upper area—preferably at the highest point in the chamber—and a water outlet opening arranged in a lower area—preferably at the lowest point in the chamber. A water outlet valve is located on or in the water outlet aperture, which valve is activated as a function of a water level in the chamber. In a particularly preferred embodiment, the water outlet valve is controlled by a float arranged in the chamber and coupled to the water outlet valve. This design is extraordinarily simple and cost-effective and needs no external control.

In a particularly simple variant, the valve consists essentially of a valve body, for example, a valve cone, a valve disk or the like, which when the valve is in the closed state presses against a valve seat arranged on the inside of the water outlet aperture. The float in this case can be maintained in the chamber such that it is located above the valve body and is coupled to the valve body directly by means of a push rod or the like. As soon as the water level falls below a certain level, the float presses the valve body into the valve seat. Above a certain water level, the float lifts the valve body from the valve seat. In a quite especially cost-effectively and space-savingly designed exemplary embodiment, the float has on its lower end an integrated valve-cone section which interacts with a valve seat arranged in or on the water outlet aperture. A separate valve body and a coupling with the float can then be dispensed with.

Alternatively, a coupling can also be effected via a lever arm, it being possible for the force of the float on the valve body to be adjusted by means of the configuration of the lever arm in order in this way to determine the force with which the valve body presses into the valve seat, and thus the tightness of the valve.

The water outlet aperture is preferably connected to an inlet of the heating device, optionally via a water reservoir of the coffee machine and/or via the pump, for example to the pump feed, such that the water discharged from the steam separator is refed to the water heater.

Where a shared heating device is used for heating water for preparing coffee and for generating steam, the control device for setting whether steam is generated or whether steam is emitted through the steam outlet comprises a first valve connected downstream of the heating device, which first valve in a first switching state blocks the connection from an outlet of the heating device to the brewing chamber and in a second switching state blocks the connection from an outlet of the heating device to the steam separator and/or to the steam outlet. This valve optionally also has a third switching state in which it is completely closed. For example, this valve can have a valve inlet which in a first switching state is connected to a first valve outlet which is connected to the brewing chamber. In a second switching state, this valve inlet of the valve can then be connected to a second valve outlet which is connected to the steam separator and/or the steam outlet.

The control system preferably also includes a suitable temperature control for the heating device which is designed in such a way that the heating device is set to the appropriate temperature as a function of the operating mode. In addition, the control system then preferably also has a pump control which in a steam-generating operating state of the heating device ensures that the pump feeds the water to the heating device in the desired cycle.

The temperature control and optionally the pump control can in this case also be integrated in a control unit. Provided the first valve is an electrically or electronically controllable valve, the first valve can, for example, also be controlled via this control unit. Alternatively, it is also possible for the first valve to be a mechanically switchable valve and for the valve position to be detected via a sensor, a valve position signal being fed to the control unit, which then ensures the appropriate temperature adjustment and the appropriate pump activation are made.

Particularly where a steam separator is used, it can arise that the steam generated will escape from the steam outlet even after the first valve has been switched over. In order to prevent this, a second valve is preferably located between the steam separator and the steam outlet in order to interrupt the line between the steam separator and the steam outlet. This second valve is preferably coupled to the first valve such that the second valve is closed when the connection of the heating device to the steam separator is also closed. This second valve can in this case be coupled to the first valve in such a way that both valves are integrated e.g. in a shared valve block and thus are switched jointly.

In principle, any steam outlet nozzle (cappuccino nozzle) can be used at the steam outlet. A particularly preferred embodiment here is a so-called Venturi nozzle in which one or more fine bore holes are located in the outlet tube or in the nozzle immediately upstream of the nozzle outlet, through which bore holes, when steam is being discharged, milk can be sucked which is then emitted again via the steam outlet. Such a nozzle, which operates according to the Venturi principle, simplifies the frothing of milk.

The invention will be explained once again in detail below with reference to the enclosed drawings based on exemplary embodiments. As far as possible, the same reference characters will be used here for the same features or components.

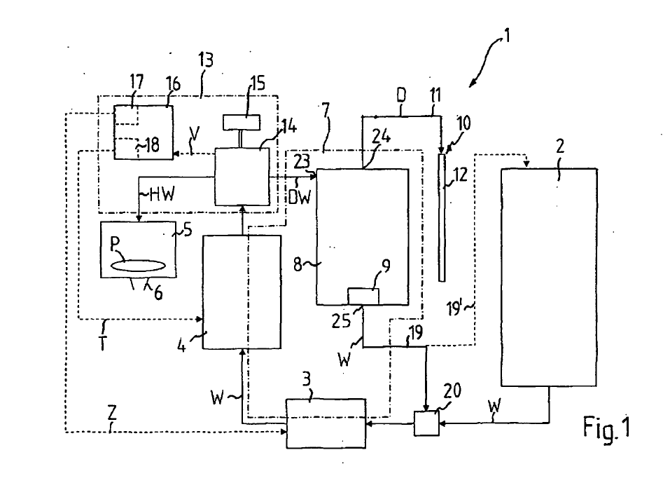

FIG. 1 shows a schematic representation of the components, and their interaction, of an inventive pad coffee machine according to a first exemplary embodiment;

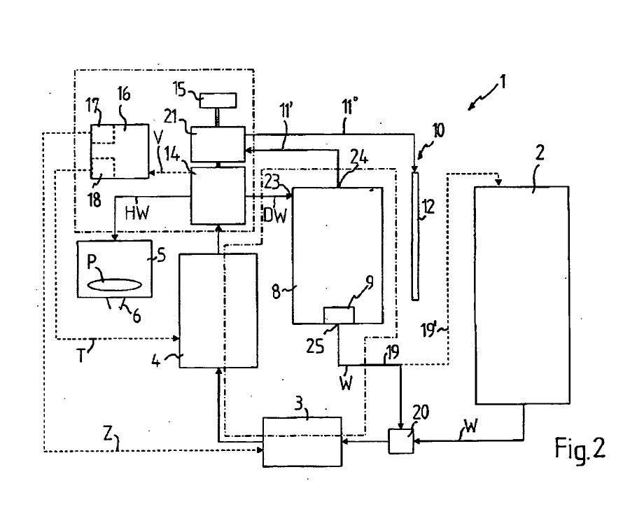

FIG. 2 shows a schematic representation of the components, and their interaction, of an inventive pad coffee machine according to a second exemplary embodiment;

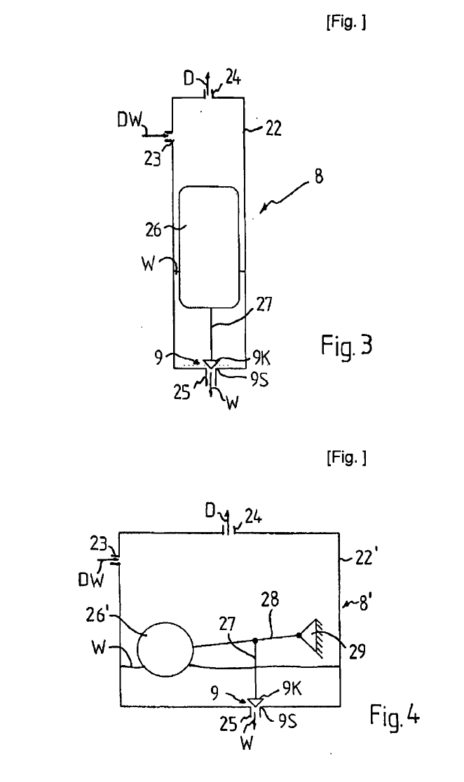

FIG. 3 shows a schematic representation of a steam separator according to a first exemplary embodiment;

FIG. 4 shows a schematic representation of a steam separator according to a second exemplary embodiment;

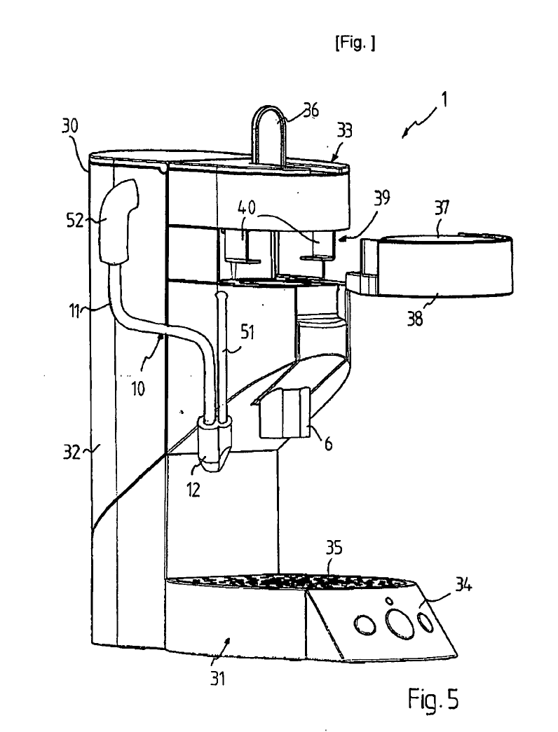

FIG. 5 shows a perspective exterior view of an exemplary embodiment of a coffee machine according to the invention;

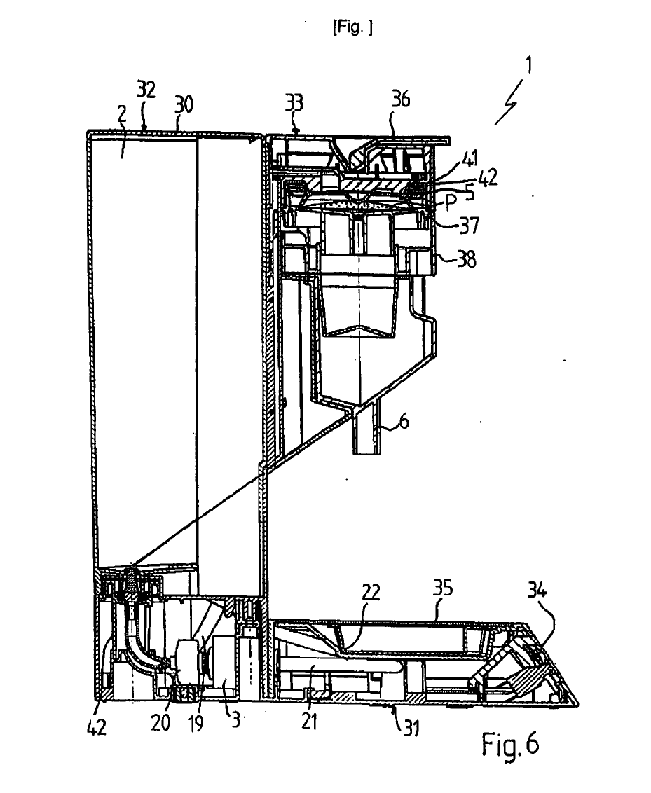

FIG. 6 shows a vertical partial longitudinal section through a coffee machine according to FIG. 5;

FIG. 7 shows a view of the key components for generating hot water and steam and their spatial arrangement in a coffee machine according to FIGS. 4 and 5 (interior view of the coffee machine from the rear with water tank removed);

FIG. 8 shows a representation of a valve used in an inventive coffee machine according to FIGS. 4 to 6;

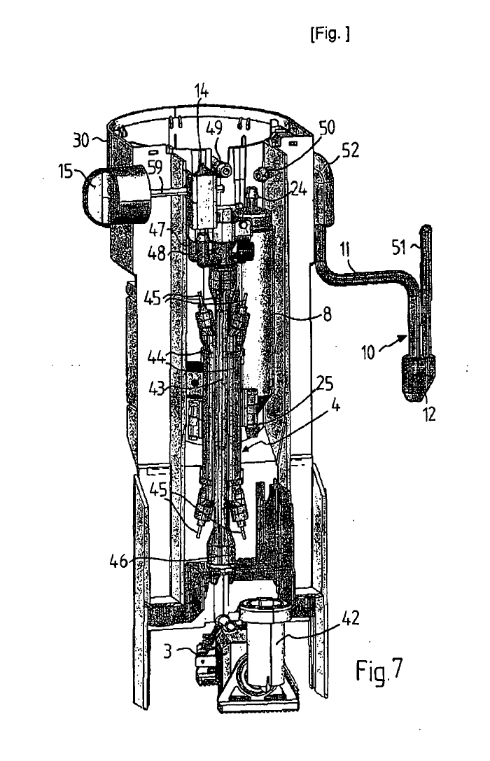

FIG. 9 shows a representation of a second exemplary embodiment of a corresponding valve;

FIG. 10 shows a representation of a third exemplary embodiment of a corresponding valve.

The first exemplary embodiment of an inventive coffee machine 1 shown in FIG. 1 in the form of a functional diagram has in a conventional manner a water tank 2 into which the water needed for preparing coffee and for generating steam is poured by the user. From this water tank 2, the water can be pumped by means of a pump 3 to a heating device 4, here a continuous-flow heater 4.

In the continuous-flow heater 4, the water is heated and can be fed in a coffee preparation mode of the coffee machine 1 in a usual manner as hot water HW under a pressure of 3 bar maximum to a brewing chamber 5 in which a coffee pad P is located. Flavorings and colorings in the ground coffee located in the coffee pad P are released by the hot water HW, whereby coffee is produced. The coffee can then be drawn off via an outlet 6.

Besides these usual components, the inventive coffee machine 1 has a steam generator 7 by means of which hot steam can be provided. A suitable steam outlet 10 is arranged on this steam generator 7, consisting here of a steam tube 11 and a cappuccino nozzle 12 connected at the end in order to draw off steam D for example for frothing milk. In addition, the coffee machine 1 has a control system 13 in order to be able to switch between the coffee-preparing mode and a steam-generating mode, in which steam is generated. The components associated with the steam generator 7 are enclosed in FIG. 1 by a dash-dot line, some of the components, namely the pump 3 and the heating device 4 being used not only for generating steam but also for preparing the hot water for preparing coffee. These components 3,4 are therefore only partially assigned to the steam generator 7. Besides these dual-use functional units, i.e. besides the pump 3 and the continuous-flow heater 4, the steam generator 7 also has a steam separator 8 to which the steam/water mixture DW coming from the continuous-flow heater 4 is fed in order that the steam component D is separated from the water component W.

The functional principle of a simple variant of a suitable steam separator 8 can be seen from FIG. 3. The steam separator 8 consists of a chamber 22 which at its highest point has a steam outlet aperture 24 from which the hot steam D can escape. Located on the underside at the lowest point is a water outlet aperture 25 through which the water component W can exit the chamber 22 again. Located in the side wall is an inlet aperture 23 for the steam/water mixture DW. The chamber 22 of the steam separator 8 is preferably of a cylindrical design and embodied such that the steam separator 8 can absorb an adequate pressure. The pressure in the steam separator 8 can reach up to 2 bar and more during operation. The water outlet aperture 25 is closed by a valve 9. This valve 9 is controlled via a float 26 which is arranged inside the chamber 22.

The valve 9 consists in this case essentially of a valve body 9K, here a valve cone 9K, which in the closed state of the valve 9 presses against a valve seat 9S arranged on the inside of the water inlet aperture 25. The valve body 9K is coupled in FIG. 3 via a push rod 27 to the float 26 floating thereabove in the water W located in the chamber 22. As soon as the water level falls below a certain level, the float 26 forces the valve body 9K into the valve seat 9S and the valve 9 is closed. If the water level rises above a certain height, the float 26 ensures that the valve body 9K is lifted from the valve seat 9S and the water outlet valve is opened. The valve body can also be part of the float, i.e. the float can, for example, be designed conically on the underside, this conical underpart interacting with a conical first section of the water outlet aperture designed correspondingly as a valve seat.

A variant of a steam separator is shown in FIG. 4. This steam separator 8′ also has a correspondingly pressure-proof chamber 22′ comprising a steam outlet aperture 24 at the top, a water outlet aperture 25 at the bottom and an inlet aperture 23 at the side for the steam/water mixture DW. The chamber 22′ of the steam separator 8′ can here also be cylindrically structured, but can for example also be structured cuboidally or in another shape. A water outlet valve 9′ comprising a valve body 9K and a valve seat 9S is also located on the water outlet aperture 25 in this exemplary embodiment. The valve body 9K is in turn coupled via a push rod to a float 26′ in the interior of the chamber 22′ such that, when the float 26′ is lifted upward by a rise of the water level in the interior of the chamber 22′, the valve 9′ is opened and when the float 26′ falls, the valve body 9K is pressed into the valve seat 9S again and the water outlet valve 9′ is closed. However, the push rod 27 here is not coupled directly to the float 26′, but the float 26′ is fastened to a lever arm 28 which is supported rotatably about a horizontal axis on a holder 29 fastened firmly in the chamber 22. The push rod 27 is in this case coupled to the lever arm 28. Provided the point at which the push rod 27 is connected to the lever arm 28 lies in the correct position between the float 26′ and the holder 29 in the chamber 22′, the float 26′ can exert a greater force on the valve body 9K so that a tighter closing of the water outlet valve 25 can be ensured than in the exemplary embodiment according to FIG. 3. An adjustment of the closing force is possible by changing e.g. the position of the float 26′ along the lever arm 28. The disadvantage of this design, however, is the greater amount of space required. The concept shown in FIG. 3 is therefore used for a preferred exemplary embodiment with a low space requirement.

In addition, a type of baffle or such like (not shown in the figures) can be arranged in the chamber in front of the inlet aperture 23, on which baffle the steam/water mixture D/W coming through the inlet aperture 23 impinges such that the water droplets present in the steam condense there and then drip downward into the chamber 22,22′. When sufficient water has accumulated in the chamber, the float 26,26′ is raised and then opened through the valve 9,9′ so that the water exits the steam separator 8,8′again through the water outlet 25.

The water W discharged through the water outlet aperture 25 is, as shown in FIG. 1, carried again via a line 19 in a connecting piece 20 into the line between water tank 2 and pump 3. Alternatively, the water W can also be carried back from the water outlet aperture 25 via a line 19′ into the water tank 2 again. This is shown by the dashed line 19′ in FIG. 1. The connecting piece 20 can in this case be dispensed with.

The control system 13 by means of which the switch can be effected between coffee preparation mode and steam generation mode, consists of multiple components 14, 15, 16, which are likewise grouped together here by a dashed-line block. The core of this control system 13 in the exemplary embodiment according to FIG. 1 is a 3/2-way valve 14 which can be adjusted by a user mechanically via a rotary valve switch 15. This valve 14 has three switch positions. In a first switch position, the valve inlet connected at the outlet of the heating device 4 is connected to a first valve outlet to which the brewing chamber 5 is connected. In a further switch position, the valve inlet is connected to a second valve outlet which is connected to the inlet aperture 23 of the steam separator 8. In the intermediate switch position, the valve is closed.

Furthermore, the control system 13 has an electronic control unit 16 which comprises as components a pump control 17 and a temperature control 18. This control unit 16 can for example be a microprocessor, ASIC or the like, it being possible for the pump control 17 and the temperature control 18 to be realized in the form of software.

It is evident that the coffee machine will have an on/off switch as well as all necessary components in order to transform a supply voltage—fed via a normal plug by means of a cable—such that the electrical components inside the coffee machine can be supplied herewith. Over and above this, the machine can also have still further known functional units such as e.g. an operating status indicator, a liquid level indicator, a calcification warning lamp, a warming plate, a pressure indicator, etc. For the sake of clarity, however, such standard components are not shown in FIG. 1.

A suitable metering element (not shown) is located in the valve 14, via which metering element the switch position of the valve 14 can be detected and a suitable valve position signal V representing the valve position transferred to the electronic control unit 16 or picked up by the electronic control unit 16.

The mode of operation of the coffee machine according to FIG. 1 is as follows:

In a first switch position, in the coffee preparation mode, water W is pumped from the water tank 2 via the pump 3 to the continuous-flow heater 4. This pumping is carried out continuously, i.e. the pump control 17 of the electronic control unit 16 activates the pump 3 such that the pump 3 continuously forces water into the heating device 4. The continuous-flow heater 4 is set to approx. 100° C. in this coffee preparation mode by means of a temperature signal T coming from the heating control module 18 of the electronic control unit 16. In the valve 14, the hot water HW is then conducted for coffee preparation into the brewing chamber 5.

After the user has drawn off the coffee via the outlet 6, he can switch the valve 14 with the aid of the rotary valve switch 15 to the second switch position so that the outlet of the heating device 4 is connected to the inlet aperture 23 of the steam separator 8. The change in the valve position is registered by the electronic control unit 16, which thereupon ensures that, by means of a time-control signal Z, the pump control 17 switches the pump 3 in a certain time cycle, the pump 3 being switched on for 0.6 s approximately every 5 s. Simultaneously, it is ensured via the temperature control 18 that the continuous-flow heater 4 is set to approx. 130° C. The water W flowing cyclically into the continuous-flow heater 4 is evaporated at the temperature of 130° C. and the steam then passes via the valve 14 with a residual component of water as a steam/water mixture or wet steam into the steam separator 8.

In the steam separator 8, the wet steam is as far as possible separated from the water component W, and the steam D can then be drawn off from the steam nozzle 12 of the steam outlet 10 in order for example to froth milk.

The user can then switch the valve 14 by means of the rotary valve switch 15 to the third switch position. In this switch position, the valve 14 is closed. This valve position is likewise determined by the electric control unit 16, and the control unit 16 accordingly ensures that the pump 3 is deactivated via the pump control 17 and the continuous-flow heater 4 is switched off via the temperature control 18. Only the residual steam located in the steam separator 8 then escapes.

In order to prevent this, a further valve 21 can be used—as shown in FIG. 2. The coffee machine 1 according to FIG. 3 is essentially structured in exactly the same way as the coffee machine according to FIG. 1. In contrast to the coffee machine according to FIG. 1, however, this coffee machine has a second valve 21 included in the control system 13, such that the control system 13 can also set whether steam D already prepared in the steam separator 8 is then discharged by the steam outlet 10. This second valve 21 is located between the steam outlet aperture 24 of the steam separator 8 and the steam nozzle 12 of the steam outlet arrangement 10. Instead of a simple steam tube 11 to the nozzle 12, for this purpose firstly a first steam discharge piece 11′ is arranged at the steam outlet aperture 24 of the steam separator 8, which piece leads to the valve 21, and a steam tube 11′ then leads finally from the outlet of the valve 21 to the nozzle 12. The second valve 21 is coupled here to the first valve 14 such that the second valve 21 is closed when the first valve 14 is in the third switch position. Alternatively, the second valve 21 could also be structured and e.g. furnished with its own switch such that it is switchable independently of the first valve 14.

The mechanical layout and the spatial arrangement of the components relative to one another are described below in an exemplary embodiment of the inventive coffee machine based on FIGS. 5 to 7.

As can be seen from FIGS. 5 and 6 in particular, the coffee machine 1 in the exemplary embodiment shown has a flat front part 31, a columnar rear module 32 and an upper module 33 extending forward above the front part 31 from the columnar rear module 32.

Located in the upper part of the columnar module 32 is the water tank 2 which is closed on the top by a lid and can be filled from above once the lid has been opened. Located in the upper module 33 is the brewing chamber 5 into which the coffee pads P can be inserted.

The coffee pads P are inserted in a pad holder 37 which is located in a drawer 38 which can be pushed into a slide-in area 39 in the upper module 33. The pad holder 37 forms the lower part of the brewing chamber. Located in the slide-in area 39 are clamps 40 which—as soon as the drawer 38 is inserted into the slide-in area 39, grip the pad holder 37 from below. These clamps 40 are coupled to a tensioning lever 36 mounted in an upwardly swivelable manner on the top side of the upper module 33, said lever being tilted up when the brewing chamber is in the open state, as shown in FIG. 6. If this tensioning lever 36 is folded forward, then the clamps 40 are pulled upward and the pad holder 37 with the inserted coffee pad P is in this way pressed upward by the clamps 40 against a brewing-chamber upper section 41. This can be seen in the sectional view shown in FIG. 6. As can be seen there, the brewing-chamber upper section 41 has a circumferential flexible seal 42 which, when the pad holder 37 is pulled upward presses in the shape of a ring against the base of the pad holder 37 such that the brewing chamber 5, in which the coffee pad P is located, is formed between the area of the brewing-chamber upper section 41 located inside the seal 42 and the pad holder 37.

A coffee outlet 6 is arranged below the brewing chamber on the underside of the upper module 33 above the front part 31. The front part 31 has on the top a standing surface 35 on which cups can be placed below the coffee outlet 6 in order to be filled with coffee. The standing surface 35 on which the cups stand is designed in the manner of a sieve. Under the standing surface 35 is a collecting tray 22 in case the coffee drips past the coffee cup or coffee continues to flow out of the outlet 6 when the user has already removed the cups. The collecting tray 32 can be removed for cleaning. Located on the front side of the front part 31 is a control panel with control lights and a switch for switching the coffee machine on and off.

As FIG. 5 shows, a steam outlet tube 10 with a nozzle 12 is arranged in the upper area on the one side of the columnar rear module 32. The steam outlet tube 10 initially runs in a first section vertically downward, then has a second horizontal section angled laterally away from the columnar module 32 and then bends again into a third section running vertically downward. The upper first section of the steam tube 11 is swivelably mounted about a vertical axis on a connecting piece 52 fastened to the housing 2 of the coffee machine 1. The swiveling can, since the steam tube 11 is hot when in operation, be effected with the aid of a guide rod 51 fastened to the nozzle 12, which rod remains largely cold even when the steam nozzle 12 is in operation.

In the partial cross-section shown in FIG. 6, it can be seen that a water-tank connector 42 is arranged below the water tank 2 located in the upper rear part of the columnar module 32, via which connector the water passes from the water tank 2 to a pump 3 which is located in the lower front area of the columnar module 32. Located between the water-tank connector 42 and the pump 3 is a connecting piece 20 in which, via a line 19, the water from the steam separator 8 is conducted back again to the pump feed 3. A line 21 leads from pump 3 through the front part back up to the continuous-flow heater 4 which extends in a vertical direction in the columnar module 32 in front of the water tank 2 above the pump 3. This arrangement of the continuous-flow heater 4 can be seen from FIG. 7, which shows the front part of the columnar rear module 32 viewed from the rear with the water tank 2 removed. From the continuous-flow heater 4, the water passes during coffee preparation via the valve 14 to the brewing chamber 5. The finished coffee then drips down through the outlet into a cup 6 provided on the front part 31.

FIG. 7 also shows once again the further key components for producing the coffee water and for generating steam. Shown in the lower front area is the water-tank connector. The pump 3 is located behind it. Arranged above the pump 3 is the continuous-flow heater 4 which consists of a central conduit 43 extending vertically on two sides of which heater bars 44 are arranged. These heater bars 44 each have electrical contacts 45 top and bottom to which the necessary voltage is applied in order for the heater bars 44 to heat up. In steam mode, preferably only one of the heater bars 44 is used in order to prevent an overheating of the continuous-flow heater 4 during steam generation. In principle, however, the continuous-flow heater 4 can also have only one heater bar or else more than two heater bars. The material of the conduit 43 and the connecting materials between the heater bars 44 and the conduit 43 are chosen such that as much heat as possible is given off to the conduit 43 and the water pumped therethrough. During the heating, the water is pumped upward by the pump 3 from a continuous-flow-heater inlet 46 lying below.

At the upper end, there are located on the continuous-flow heater 4 in the exemplary embodiment shown two outlets 47 and 48. The one outlet 47 is connected via a hose to a brewing-chamber connector 49 which runs from the columnar rear module 32 into the front upper module 33 and leads there to the brewing chamber. The connecting hose (not shown here) leads through a valve 14 which will be described in detail below with reference to FIG. 8. The other outlet 48 of the continuous-flow heater leads likewise through this valve 14 and from there into a lateral inlet aperture (cannot be seen in this Figure) of a steam separator 8 which here is arranged parallel alongside the continuous-flow heater 4.

The continuous-flow heater 8 has a design as has already been explained schematically with reference to FIG. 3. The water-outlet aperture 25 on the bottom is connected via a hose to the connecting piece 20 (not visible in FIG. 7) between the water-tank connector 42 and the pump 3. The steam outlet 24 at the upper end of the steam separator 8 is connected via a hose (not shown) to a steam tube connection 50. The steam D passes through this steam tube connection 50 into the steam tube 11 and from there via the nozzle 12 to the outside. In the exemplary embodiment shown here, no further valve is located between the steam outlet aperture 24 of the steam separator 8 and the steam outlet 10, i.e. this is a coffee machine according to the design shown in FIG. 1.

The valve 14 shown in FIG. 7 is a hose valve constructed in a particularly simple and cost-effective manner, which hose valve is based upon the principle that to interrupt a line, a piece of hose is simply mechanically clamped. This principle can be seen from a section of the valve 14 in FIG. 8. The valve 14 consists of a rectangular housing 56, open top and bottom, through which two hose pieces 57, 58 are guided. The one hose piece 57 connects the first continuous-flow heater outlet 47 to the brewing-chamber connector 49 and the other hose piece 58 connects the second continuous-flow heater outlet 48 to the inlet aperture of the steam separator 8. The two hose pieces 57, 58 each run from bottom to top parallel along the insides of the longitudinal walls of the valve housing 56. There are located between the two hose pieces 57, 58 flexible clamping clips 54, 55 which, depending on the position of a cam disk 53 rotatably mounted between the clamping clips 54, 55, are either pressed outward in the direction of the adjacent longitudinal wall of the valve housing 56 or remain in a position running parallel to the longitudinal wall.

In the position shown in FIG. 8, the cam disk 53 is set such that only the flexible clamping clip 55 located on the right in FIG. 8 is pressed against the right longitudinal wall and the hose piece 58 is consequently clamped. The connection from the continuous-flow heater 4 to the steam separator 8 is blocked by this means. The left-hand flexible clamping clip 54 runs parallel to its adjacent longitudinal wall such that the other hose piece 57 is not clamped. That is, the connection from the continuous-flow heater 4 to the brewing-chamber connector 49 is opened (coffee preparation mode). The cam disk 53 is connected via a shaft 59 to a rotary valve switch 15 arranged on the outside of the housing 2 of the coffee machine (see FIG. 7). By means of the rotary valve switch 15, the cam disk 53 can be rotated about 90 degrees further to the left (in FIG. 8) such that both flexible clamping clips 54, 55 press in the direction of their adjacent longitudinal wall of the valve housing 56 and consequently both hose pieces 57, 58 are clamped. In this valve position, water cannot be processed for coffee nor can steam be generated. If the cam disk 53 is rotated via the rotary valve switch 15 about a further 90 degrees to the left, the valve 14 is in a switching state in which only the hose piece 57, i.e. the connection between continuous-flow heater 4 and brewing chamber 5 is clamped and the connection from the continuous-flow heater 4 to the steam separator 8 is open (steam-generating mode). Via a suitable sensor (not shown in FIGS. 7 and 8), the switch position of the valve 14 can be interrogated and this value transmitted to the electronic control unit (see FIG. 1), which—as described in connection with FIGS. 1 and 2—triggers the continuous-flow heater 4 and the pump 3 according to the operating mode chosen. Advantages of the valve shown in FIGS. 7 and 8 are the cost-effective, simple design and the low risk of calcification.

FIG. 10 shows a different type of valve, which can be used as an alternative to the valve 14. This valve 14′ is even more space-saving than the valve 14 shown in FIG. 8. It consists of a cylindrical valve housing 62 with three connectors 63, 64, 65 which are respectively arranged at an angle of 90 degrees to one another. The connector 63 can be connected as a valve inlet to an outlet of the continuous-flow heater 4. The valve outlets 64, 65 can be connected to inlets of the steam separator 8 and of the brewing chamber 6. There is fitted in the interior of the valve housing 62 a disk-shaped valve body 66, which can be rotated about the longitudinal axis (lying vertical in the plane of the drawing) of the valve housing 62. There are located in this valve body 66 two blind holes 67, 68, which likewise stand at an angle of 90 degrees to one another and are connected to one another in the center of the valve body 66. Depending on the position of the valve body 66, either the valve inlet 63 coincides with the second blind hole 68 and the first blind hole 67 with the valve outlet 65 such that the inlet 63 and the left-hand outlet 65 in the figure are connected to one another, or the valve inlet 63 coincides with the first blind hole 67 and the right-hand valve outlet 64 with the second blind hole 68, i.e. the inlet 63 is connected to the right-hand outlet 64. In every other position in which the blind holes 68, 67 do not coincide with an inlet 63 or an outlet 65, 64, the valve 14′ is completely closed.

FIG. 10 shows a third variant of a suitable valve 14′. Here, all the connections are realized by means of bores 61 in a valve block. Inside the valve block, a valve body 60, coupled to a rotary valve switch 15, is arranged on a shaft 59. The corresponding passages through the valve 14″ are opened or closed by virtue of the position of the valve body inside the valve block, depending on the position of the rotary valve switch 15.

In conclusion, it is once again pointed out that the preceding coffee machines described in detail are exemplary embodiments, which can be modified by a person skilled in the art in a wide variety of ways without departing from the scope of the invention. In particular, the specific designs of the valves can be realized in a different form from that described here. Likewise, the continuous-flow heater can be designed in a different form if this is necessary for reasons of space or on design grounds.

1-13. (canceled)

14. A coffee machine comprising a heating device for heating water, a brewing chamber for accommodating a coffee pad, to which brewing chamber water heated by the heating device is fed in order to release flavorings from a coffee pad arranged in said brewing chamber, and an outlet for the coffee so produced, wherein the coffee machine comprises a steam generator with a steam outlet for providing steam.

15. The coffee machine as claimed in claim 14, wherein the heating device comprises a continuous-flow heater.

16. The coffee machine as claimed in claim 14, wherein the coffee machine has just one heating device.

17. The coffee machine as claimed in claim 16, wherein the brewing chamber is fed the heated water under a pressure of 3 bar maximum by the just one heating device.

18. The coffee machine as claimed in claim 16, wherein the coffee machine comprises a control system by means of which the just one heating device can be switched at least between two operating states, wherein the just one heating device in a first operating state heats water to a first temperature value for preparing coffee and in a second operating state heats water to a second temperature value for generating steam.

19. The coffee machine as claimed in claim 14, wherein the heating device comprises a pump and a pump control assigned to the pump, which pump control is designed such that in a steam-generating operating state the pump feeds water to the heating device in a predetermined cycle.

20. The coffee machine as claimed in claim 14, wherein the steam generator comprises a steam separator.

21. The coffee machine as claimed in claim 20, wherein the steam separator comprises a chamber with an inlet aperture for a steam/water mixture, with a steam outlet aperture arranged in an upper area of the chamber and with a water outlet aperture arranged in a lower area of the chamber with a water outlet valve for the water outlet aperture, which valve is activated as a function of a water level in the chamber.

22. The coffee machine as claimed in claim 21, wherein the steam separator has a float arranged in the chamber, which float is coupled to the water outlet valve.

23. The coffee machine as claimed in claim 21, wherein the water outlet aperture is connected to an inlet of the heating device such that the water discharged from the steam separator is fed again to the heating device.

24. The coffee machine as claimed in claim 14, further comprising a first valve connected downstream of the heating device, which valve in a first switching state blocks the connection from an outlet of the heating device to the brewing chamber and in a second switching state blocks the connection from an outlet of the heating device to the steam separator or to the steam outlet.

25. The coffee machine as claimed in claim 24, further comprising a second valve arranged between the steam separator and the steam outlet.

26. The coffee machine as claimed in claim 24, wherein the first valve is coupled to the second valve.
